(19) United States
(12) Patent Application Publication
(10) Pub. No.: US 2014/0061467 A1
(43) Pub. Date: Mar. 6, 2014

(54) VARIABLE APERTURE MECHANISM FOR USE IN VACUUM AND CRYOGENICALLY-COOLED ENVIRONMENTS

(71) Applicants: Robert Buzerak, Santa Barbara, CA (US); David Marshall, Thousand Oaks, CA (US)

(72) Inventors: Robert Buzerak, Santa Barbara, CA (US); David Marshall, Thousand Oaks, CA (US)

(73) Assignee: Teledyne Scientific & Imaging, LLC

(21) Appl. No.: 13/605,789

(22) Filed: Sep. 6, 2012

(51) Int. Cl. G02B 26/02; G01J 5/08

(52) U.S. Cl. 250/338.1; 359/230

(57) ABSTRACT

A variable aperture mechanism (VAM) comprises a cam assembly, a single motor capable of rotating the cam assembly, and a pair of aperture members which are coupled to the cam assembly and arranged to affect the size of an aperture, with the size of the aperture varying with the position of the cam assembly. The VAM would typically be used with a sensor having an associated optical field-of-view (FOV), with the aperture members moving in and out of the FOV with the rotation of the cam assembly such that the aperture can be set to multiple f-numbers. A thermal link between the aperture members and a cryogenically-cooled surface ensures that the aperture members are also cryogenically-cooled.

### BACKGROUND OF THE INVENTION

1. Field of the Invention

This invention relates generally to variable apertures, and more particularly to variable apertures capable of operating in a vacuum and cryogenically-cooled environments.

2. Description of the Related Art

Some photodetectors, such as those commonly found in infrared (IR) sensors, require very low temperatures for optimum performance. For example, typical IR sensors are designed to operate in an environment that has been cryogenically-cooled to temperatures below 150° K; the sensors are also typically operated in a vacuum.

Such sensors are typically part of an imaging system which includes optical elements that affect the electromagnetic radiation that reaches the sensor. One such element is a variable aperture mechanism (VAM), which is mounted in front of the IR sensor and is used to control the sensor's field-of-view (FOV). Since the target and the VAM are both in the sensor's FOV, to improve the overall system sensitivity the VAM needs to be cryogenically cooled so that the thermal signature of the VAM does not compete with that of the target.

However, maintaining reliable operation of the VAM in a vacuum and at cryogenic temperatures can be problematic. One known design employs three motors to operate the moving elements of the VAM; however, this arrangement requires that the motors be precisely aligned, and fails to operate if any of the motors fails. Other approaches require complex mechanical designs that thermally isolate the drive motor from the moving elements; however, the required complexity can result in unreliable operation.

### SUMMARY OF THE INVENTION

A variable aperture mechanism (VAM) is presented which addresses the challenges noted above, providing reliable operation in a vacuum and cryogenically-cooled environment.

The present VAM comprises a cam assembly, a single motor capable of rotating the cam assembly, and a pair of aperture members which are coupled to the cam assembly and arranged to form an aperture, the size of which varies with the position of the cam assembly. The motor is preferably a piezoelectric motor, and the cam assembly preferably includes a ceramic disc cam. The VAM is preferably arranged such that the aperture members are decoupled from the motor.

The VAM would typically be used with a sensor having an associated optical field-of-view (FOV), with the aperture members moving in and out of the FOV with the rotation of the cam assembly such that the VAM provides an aperture capable of providing multiple f-numbers. There is preferably a thermal link between the aperture members and a cryogenically-cooled surface such that the aperture members are also cryogenically-cooled. Several illustrative VAM designs are discussed, including an embodiment in which the aperture members comprise two scissors-like blades which rotate about a common pivot point, and another in which the aperture members comprise two flat blades that move linearly in opposite directions.

These and other features, aspects, and advantages of the present invention will become better understood with reference to the following description and claims.

### BRIEF DESCRIPTION OF THE DRAWINGS

FIGS. 1a and 1b are perspective views of one possible embodiment of a VAM per the present invention, showing the aperture members at their fully open and fully closed positions, respectively.

FIG. 1c is a cutaway view of the VAM shown in FIGS. 1a and 1b.

FIGS. 2a and 2b are perspective views of another possible embodiment of a VAM per the present invention, showing the aperture members at their fully open and fully closed positions, respectively.

FIG. 3 shows plane and sectional views of a VAM per the present invention which employs a sliding track module.

### DETAILED DESCRIPTION OF THE INVENTION

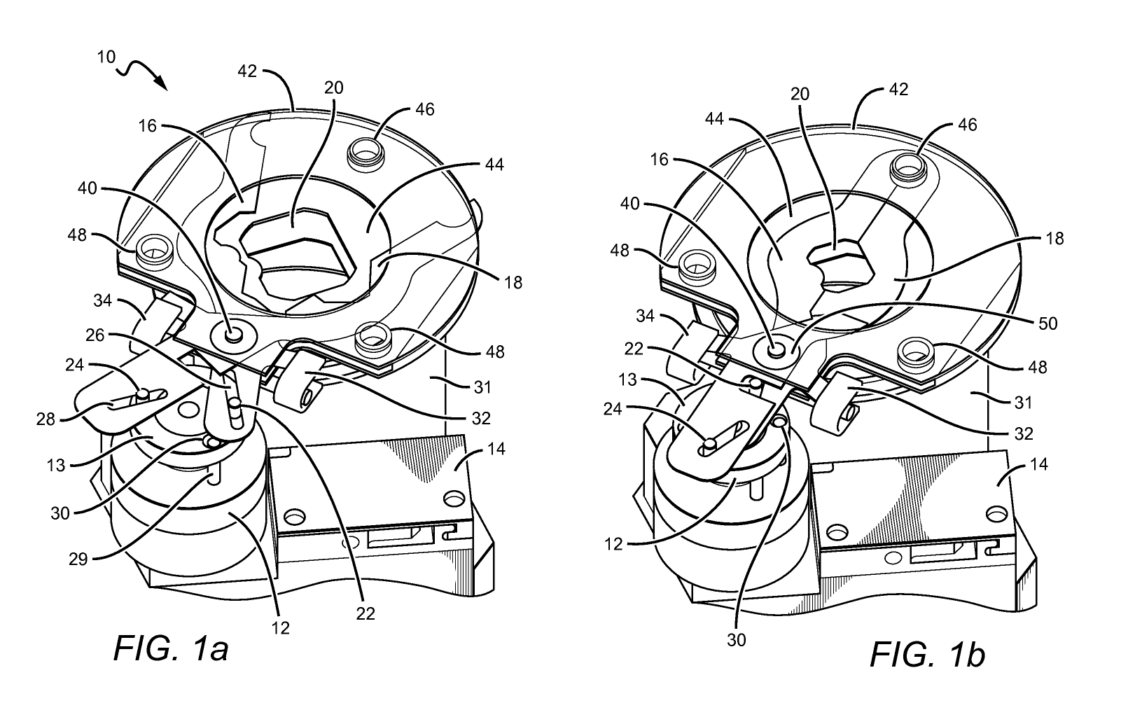

One possible embodiment of a VAM suitable for use in a vacuum and cryogenically-cooled environment is shown in FIG. 1a. The VAM 10 comprises a cam assembly which includes a drive cam 12 and a cam plate 13, a single motor 14 capable of rotating the cam assembly, and a pair of aperture members 16, 18 which are coupled to the cam assembly and arranged to affect the size of an aperture 20, with the size of the aperture varying with the position of the cam assembly.

In a preferred embodiment, the cam plate has at least two pins which extend from the cam plate in a direction normal to the plane in which the cam assembly rotates, and each of the aperture members has a hole which surrounds a respective one of the pins, such that the aperture members move with the pins. For the exemplary embodiment shown in FIG. 1a, cam plate 13 has two cam pins 22 and 24 which engage with corresponding holes 26 and 28 in aperture members 16 and 18, respectively. In operation, motor 14 is activated to cause drive cam 12 and cam plate 13 to rotate, which in turn causes aperture members 16 and 18 to move—thereby changing the size of aperture 20.

Drive cam 12 preferably has at least two drive cam pins 29 which extend from the drive cam in a direction normal to the plane in which the cam assembly rotates, and cam plate 13 preferably has corresponding cam plate holes 30 which surround respective ones of the drive cam pins such that cam plate 13 rotates with drive cam 12. Cam plate holes 30 are preferably oversized with respect to drive cam pins 29 such that aperture members 16 and 18 are decoupled from motor 14 and its associated vibration.

Motor 14 is preferably a commercial piezoelectric motor. To reduce the amount of heat conveyed to aperture members 16 and 18 via the drive mechanism, the cam assembly preferably includes a ceramic disc cam and cam pins 22 and 24 preferably have a low thermal conductivity.

The present VAM would typically be used with a sensor, such as an IR sensor, having an associated optical field-of-view (FOV). In this application, the VAM is positioned such that aperture members 16 and 18 are moved in and out of the optical FOV with the rotation of the cam assembly, thereby enabling aperture 20 to be set to one of at least two different f-numbers. The VAM may be arranged such that the cam assembly can be rotated into either of two possible positions, thereby enabling aperture 20 to be set to one of two different f-numbers. The VAM might also be arranged such that the cam assembly can be rotated into more than two positions, or arranged such that position is infinitely variable by, for example, moving the blades out of plane so that they can overlap; these embodiments would further increase the available number of f-numbers.

As noted above, the present VAM is suitably employed with an IR sensor designed to operate in an environment that has been cryogenically-cooled and in a vacuum. To improve system sensitivity, the VAM should also be cryogenically-cooled to minimize the VAM's contribution to the total signal. Thus, there is preferably a thermal link between each of the aperture members and a cryogenically-cooled surface. For example, the VAM in FIG. 1a might be used with an IR sensor (not shown) which is surrounded by a cold shield 31 which is cryogenically-cooled. Here, the thermal link is provided by thermal braids 32 and 34, which couple aperture members 16 and 18, respectively, to cold shield 31. The cam assembly (12, 13) and motor 14 are preferably outside of and decoupled from the cryogenically-cooled environment.

A cold shield 31 as might be used with an IR sensor equipped with a VAM per the present invention is suitably made from copper, or nickel. Aperture members 16, 18 preferably have a high thermal conductivity, as would be suitably provided by materials such as molybdenum, magnesium, aluminum or beryllium copper.

One possible embodiment of aperture members 16 and 18 is two scissors-like blades which rotate about a common pivot point; an example is shown in FIG. 1a, with members 16 and 18 being the blades which rotate about a common pivot point 40. The proximal ends of blades 16 and 18 are coupled to cam pins 22 and 24, respectively, such that the distal ends of the blades move together and apart and thereby affect the size of aperture 20 in response to the rotation of cam assembly 12, 13.

The distal ends of blades 16 and 18 are preferably arranged such that they lie in the same optical plane, which allows more precise control of aperture f-number and enables the tolerance allowance for the placement of the aperture relative to the image plane to be increased. The blades would typically be placed between atop plate 42 and a VAM base 44 through which pivot point 40 extends, and which may include one or more physical stops 46 which limit how far each blade can move when they are moving together, and one or more physical stops 48 which limit how far each blade can move when moving apart. Top plate 42 and VAM base 44 should also have a high thermal conductivity, as would be suitably provided by materials such as molybdenum, magnesium, aluminum or beryllium copper.

FIG. 1a shows an embodiment of a VAM which uses scissors-like blades 16, 18 as aperture elements, in which the blades are fully open and aperture 20 is at its maximum possible size. FIG. 1b illustrates the same VAM, except with blades 16, 18 fully closed such that aperture 20 is at its minimum possible size.

A cutaway view of the VAM of FIGS. 1a and 1b is shown in FIG. 1c. One or more Teflon spacers 50 may be employed between blades 16, 18 at common pivot point 40. At least a portion of each of aperture members 16, 18 may be coated with a low friction coating, though this is unlikely to be necessary in light of the use of Teflon spacers and the fact that the blades lie in the same plane.

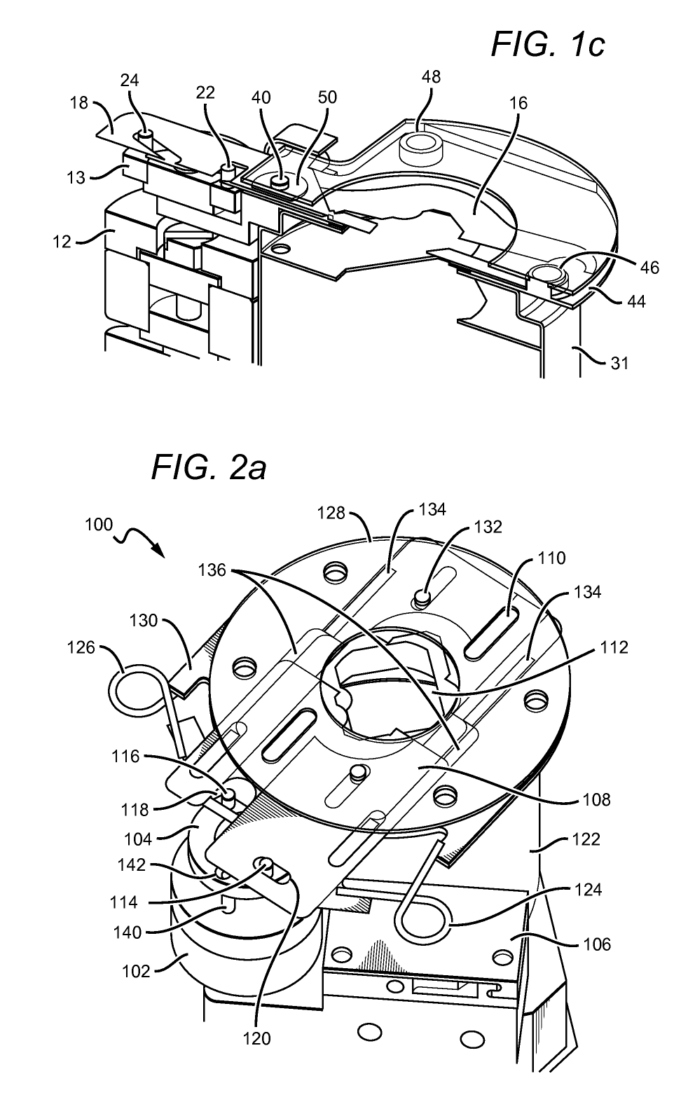

Another possible embodiment of a VAM suitable for use in a vacuum and cryogenically-cooled environment is shown in FIG. 2a. As before, the VAM 100 comprises a cam assembly which includes a drive cam 102 and a cam plate 104, a single motor 106 capable of rotating the cam assembly, and a pair of aperture members 108, 110 which are coupled to the cam assembly and arranged to affect the size of an aperture 112, with the size of the aperture varying with the position of the cam assembly. Cam plate 104 preferably has at least two pins 114, 116 which extend from the cam plate in a direction normal to the plane in which the cam assembly rotates, and each of the aperture members has a hole 118, 120 which surrounds a respective one of the pins such that the aperture members move with the pins. In operation, motor 106 is activated to cause drive cam 102 and cam plate 104 to rotate, which in turn causes aperture members 108 and 110 to move—thereby changing the size of aperture 112.

Here, however, aperture members 108 and 110 comprise two flat blades that move linearly in opposite directions. The proximal ends of flat blades 108 and 110 are coupled to pins 114 and 116, respectively, such that the distal ends of the flat blades move together and apart in a push-pull arrangement to affect the aperture size in response to the rotation of cam assembly 102, 104.

As noted above, when used with a sensor that must be operated at low temperatures, there is preferably a thermal link between each of the aperture members and a cryogenically-cooled surface. For example, the VAM in FIG. 2a might be used with an IR sensor (not shown) which is surrounded by a cold shield 122 which is cryogenically-cooled. Here, the thermal link is provided by thermal braids 124 and 126, which couple aperture members 108 and 110, respectively, to cold shield 122.

Flat blades 108, 110 would typically be placed between atop plate 128 (shown transparent) and a VAM base 130, which may include one or more blade stops 132 which limit how far each blade can travel.

FIG. 2a shows an embodiment of a VAM which uses flat blades 108, 110 as aperture elements, in which the blades are fully open and aperture 112 is at its maximum possible size. FIG. 2b illustrates the same VAM, except with blades 108, 110 fully closed such that aperture 112 is at its minimum possible size.

A VAM as shown in FIGS. 2a and 2b preferably includes at least two guide tracks which the opposing flat blades slide along when moving; the guide tracks serve to constrain out-of-plane displacement and thus maintain proper position and alignment of the blades. As is best seen in FIG. 2b, flat blade 110 slides along a guide track 134, and flat blade 108 slides along a guide track 136. The guide tracks are preferably arranged such that the opposing flat blades do not contact each other; i.e., the blades move on separate levels. To further ensure the smooth travel of the blades when cam assembly 102, 104 rotates, at least a portion of each of blades 108, 110 may be coated with a low friction coating.

Note that the blades of a flat blade embodiment as shown in FIGS. 2a and 2b do not lie in the same plane. This results in the two blades being at different distances from the sensor with which the VAM is used, which may be unacceptable in some applications.

Drive cam 102 preferably has at least two drive cam pins 140 which extend from the drive cam in a direction normal to the plane in which the cam assembly rotates, and cam plate 104 preferably has corresponding cam plate holes 142 which surround respective ones of the drive cam pins such that cam plate 104 rotates with drive cam 102. Cam plate holes 142 are preferably oversized with respect to drive cam pins 140 such that aperture members 108 and 110 are decoupled from motor 106 and its associated vibration.

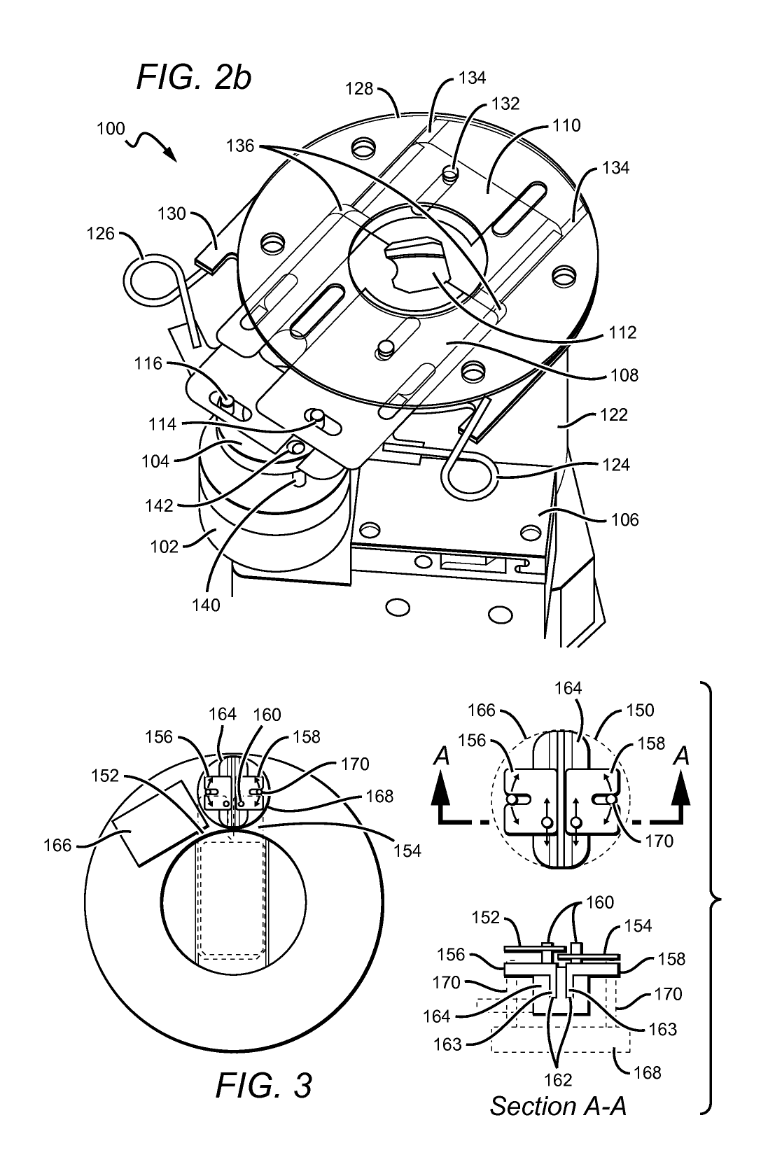

An embodiment employing flat blades might also include a sliding track module located between the proximal ends of the blades and arranged such that the force applied to the blades by the rotation of the cam is applied to the blades near their respective centerlines, which may help to maintain proper position and alignment of the blades when they are sliding. One possible implementation of such a module 150 is shown in FIG. 3, which includes plane and sectional views. Here, flat blades 152, 154 are coupled to sliding track module elements 156, 158, typically via pins 160 which extend through corresponding holes in elements 156, 158. The sliding track elements have vertical members 162 which slide in tracks 163 within a corresponding sliding track base 164. A motor 166 drives a cam 168, which is coupled to the sliding track module elements 156, 158 with pins 170. In operation, motor 166 rotates cam 168 and pins 170, causing sliding track module elements 156, 158 to move linearly within tracks 163, thereby enabling the force applied to the blades by the rotation of the cam to be applied to the blades near their respective centerlines.

One beneficial aspect of the present VAM design is that it is very compact, and able to fit within a standardized Dewar package. As such, the present VAM is likely to be backward compatible.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

We claim:

1. A variable aperture mechanism (VAM) suitable for use in a vacuum and cryogenically-cooled environment, comprising:
a cam assembly;
a single motor capable of rotating said cam assembly; and
a pair of aperture members which are coupled to said cam assembly and arranged to affect the size of an aperture, with the size of said aperture varying with the position of said cam assembly.

2. The VAM of claim 1, wherein said motor is a piezoelectric motor.

3. The VAM of claim 1, wherein said cam assembly includes a ceramic disc cam.

4. The VAM of claim 1, wherein said cam assembly has at least two pins which extend from said cam assembly in a direction normal to the plane in which said cam assembly rotates, and each of said aperture members has a hole which surrounds a respective one of said pins such that said aperture members move with said pins.

5. The VAM of claim 4, wherein said cam assembly comprises a drive cam which is rotated by said motor and a cam plate on which said at least two pins resides, said drive cam having at least two drive cam pins which extend from said drive cam in a direction normal to the plane in which said cam assembly rotates, and said cam plate has corresponding cam plate holes which surround respective ones of said drive cam pins such that said cam plate rotates with said drive cam, said cam plate holes being oversized with respect to said drive cam pins such that said aperture members are decoupled from said motor.

6. The VAM of claim 4, wherein said pins have a low thermal conductivity.

7. The VAM of claim 1, further comprising a sensor having an associated optical field-of-view (FOV), said aperture members moving in and out of said optical FOV with the rotation of said cam assembly.

8. The VAM of claim 7, wherein said VAM is arranged such that said aperture can be set to multiple f-numbers.

9. The VAM of claim 1, further comprising a thermal link between each of said aperture members and a cryogenically-cooled surface.

10. The VAM of claim 9, wherein said thermal link comprises a thermal braid.

11. The VAM of claim 9, wherein said cryogenically-cooled surface is a cold shield which surrounds an infrared sensor, said VAM affecting the size of an aperture for said sensor.

12. The VAM of claim 11, wherein said sensor and said aperture members operate in a vacuum and cryogenically-cooled environment.

13. The VAM of claim 12, wherein said cam assembly and motor are outside of and decoupled from said cryogenically-cooled environment.

14. The VAM of claim 11, wherein said cold shield comprises copper or nickel.

15. The VAM of claim 1, further comprising a VAM base and a top plate, said aperture members located between said VAM base and said top plate.

16. The VAM of claim 15, wherein said VAM base and said top plate comprise beryllium copper.

17. The VAM of claim 1, wherein said aperture members comprise molybdenum, magnesium, aluminum, or beryllium copper.

18. The VAM of claim 1, wherein said aperture members have a high thermal conductivity.

19. The VAM of claim 1, wherein at least a portion of each of said aperture members is coated with a low friction coating.

20. The VAM of claim 4, wherein said pair of aperture members comprise two scissors-like blades which rotate about a common pivot point, the proximal ends of said blades coupled to respective ones of said pins such that the distal ends of said blades move together and apart to affect the size of said aperture in response to the rotation of said cam assembly.

21. The VAM of claim 20, further comprising a Teflon spacer between said blades at said common pivot point.

22. The VAM of claim 20, wherein the distal ends of said blades are arranged such that they lie in the same plane.

23. The VAM of claim 20, further comprising physical stops which limit how far each blade can move when said blades are moving together, and when said blades are moving apart.

24. The VAM of claim 4, wherein said pair of aperture members comprise two flat blades that move linearly in opposite directions, the proximal ends of said blades coupled to respective ones of said pins such that the distal ends of said blades move together and apart in a push-pull arrangement to affect the size of said aperture in response to the rotation of said cam assembly.

25. The VAM of claim 24, further comprising at least two guide tracks, said flat blades arranged to slide along respective guide tracks when moving.

26. The VAM of claim 25, wherein said guide tracks are arranged such that said flat blades do not contact each other.

27. The VAM of claim 24, further comprising a sliding track module located between the proximal ends of said flat blades and arranged such that the force applied to said flat blades by the rotation of said cam assembly is applied to said flat blades near their respective centerlines.

28. An infrared (IR) sensor device for use in a vacuum and cryogenically-cooled environment, comprising:
an IR sensor having an associated optical field-of-view (FOV);
a cold shield which surrounds said sensor;
a variable aperture mechanism (VAM), comprising:
a cam assembly;
a piezoelectric motor capable of rotating said cam assembly, said cam assembly having at least two pins which extend from said cam assembly in a direction normal to the plane in which said cam assembly rotates; and
a pair of aperture members, each of which has a hole which surrounds a respective one of said pins, such that said aperture members move in and out of said optical FOV with the rotation of said cam assembly and thereby affect the size of an aperture, with the size of said aperture varying with the position of said cam assembly.

29. The VAM of claim 28, wherein said VAM is arranged such that said aperture can be set to multiple f-numbers.

30. The VAM of claim 28, further comprising a thermal link between each of said aperture members and said cold shield.

31. The VAM of claim 28, wherein said sensor and said VAM operate in a vacuum and cryogenically-cooled environment.

32. The VAM of claim 31, wherein said cam assembly and piezoelectric motor are outside of and decoupled from said cryogenically-cooled environment.
